(19) United States
(12) Patent Application Publication
(10) Pub. No.: US 2023/0249242 A1
(43) Pub. Date: Aug. 10, 2023

(54) METHOD FOR MANUFACTURING A BEAM WITH CLOSED SECTION

(71) Applicant: LATECOERE, Toulouse Occitanie (FR)

(72) Inventors: Christophe PERRIER, Occitanie Toulouse (FR); Simon RIEU, Occitanie Toulose (FR)

(73) Assignee: LATECOERE, Toulouse Occitanie (FR)

(21) Appl. No.: 18/003,327

(22) PCT Filed: Jun. 27, 2021
(86) PCT No.: PCT/EP2021/067597

§ 371 Date: Dec. 26, 2022

(30) Foreign Application Priority Data
Jul. 2, 2020 (FR) FR2006991

(51) Int. Cl. B21D 47/01; B21D 22/02; B21D 22/21; B21D 37/08; B21D 47/04; B29C 70/46

(52) U.S. Cl. CPC B21D 47/01; B21D 22/022; B21D 22/21; B21D 37/08; B21D 47/04; B29C 70/462; B64C 1/1461

(57) ABSTRACT

A method for manufacturing a beam (P1, P2) with closed section, the beam being produced by combining a first profile (P10, P20) and a second profile (P11, P21), including the following steps: producing the first profile by a first stamping of a first plate (5, 50) between a first punch (1, 10) having a first imprint and a second punch (2, 20) having a second imprint and incorporating a core (3, 30) modifying its second imprint; holding the first profile (P10, P20) on the first punch and positioning the core (3, 30) above the first profile (P10, P20); producing the second profile (P11, P21) by a second stamping of a second plate (6, 60) against the core (3, 30) between the first punch (2, 20) and the assembly formed by the superposition of the first punch (1, 10), the first profile (P10, P20) and the core.

### CROSS REFERENCE TO RELATED APPLICATION

This application is a national stage entry of PCT/EP2021/067597 filed Jun. 27, 2021, under the International Convention and claiming priority over French Patent Application No. FR2006991 filed Jul. 2, 2020.

### TECHNICAL FIELD OF THE INVENTION

The present invention relates to a method for manufacturing a beam having a closed cross section, formed by joining together a first section and a second section.

### PRIOR ART

Conventionally, in order to produce beams having a closed cross section, a first operation of stamping a first section is carried out, followed, separately, by a second operation of stamping a second section, and finally, the two sections obtained are fixed together using conventional fixing means of the screw/nut, rivet etc. type.

This type of method has the following drawbacks:

it requires the management of two separate components and therefore two references and two industrializations;

it requires an assembly operation;

the fixing elements bring about additional weight and bulk.

Such beams are used in particular to form the structure of airplane doors. Such a door is described in the patent application WO2019/229074A1. Its structure has in particular two main beams fixed along two side edges of the door, and a plurality of beams known as longitudinal beams disposed perpendicularly to the two main beams. Each longitudinal beam has an A-shaped cross section, produced by the assembly of two sections, according to the principle mentioned above.

The documents EP2163324, EP1231077 and WO2018/122489 describe general methods for manufacturing by stamping.

The aim of the invention is to propose a method for manufacturing a beam having a closed cross section, formed by joining together two sections, this method being:

simple to carry out, possibly without an assembly operation,

continuous, i.e. without the need to manufacture two separate components, separately,

and not necessarily requiring specific fixing means.

### SUMMARY OF THE INVENTION

This aim has been achieved by a method for manufacturing a beam having a closed cross section, said beam being produced by joining together a first section and a second section, said method having the following steps:

producing the first section by a first operation of stamping a first plate between a first punch having a first impression and a second punch having a second impression and incorporating a core that modifies its second impression,

keeping the first section on the first punch and positioning said core above said first section,

producing the second section by a second operation of stamping a second plate against said core between said second punch and said assembly formed by the superposition of the first punch, the first section and said core.

According to one particular feature, the method has a prior step of heating the first plate and the second plate.

According to another particular feature, the method has a step of locally heating at least one region of the first section obtained after the first stamping operation.

According to another particular feature, an intermediate punch is incorporated between the second punch and the core during the first stamping operation.

According to another particular feature, the method has a step of withdrawing the intermediate punch after the first stamping operation and before the second stamping operation.

The invention relates to a system employed to carry out the manufacturing method as defined above, the system having:

a first punch having a first impression and a second punch having a second impression,

a core intended to be fitted to the first punch in order to modify said first impression or to said second punch in order to modify said second impression.

According to one particular feature, the system has an intermediate punch intended to be positioned between the second punch and the core.

According to another particular feature, the first punch and the second punch have assembly means intended to cooperate with corresponding means present on the core.

According to another particular feature, the first punch and/or the second punch have indexing pins arranged so as to ensure the positioning of each plate to be stamped.

According to another particular feature, the system has a hinge mechanism arranged between the first punch and the second punch.

Lastly, the invention relates to a beam having an A-shaped cross section, produced by joining together a first section and a second section, the first section having, along its entire length:

two support bars,

a top wall situated on the opposite side from the support bars,

two side plates extending obliquely toward one another so as each to join a separate support bar to the top bar,

the second section having:

a flat wall and two fixing side plates that are each intended to bear on the internal face of a separate side plate of the first section,

said beam being produced using the method as defined above.

### BRIEF DESCRIPTION OF THE FIGURES

Further features and advantages will become apparent from the following detail description, which is given in conjunction with the appended figures listed below:

FIG. 1A s a perspective front view of a beam having an A-shaped cross section, which can be obtained by the method of the invention;

FIG. 1B shows a side view of the beam of FIG. 1A;

FIG. 2 shows a perspective view of the different elements of the system used to manufacture, according to the method of the invention, a beam having an A-shaped cross section such as the one in FIGS. 1A and 1B;

FIG. 3 shows a perspective view of the different elements of the system used to manufacture, according to the method of the invention, a beam having an A-shaped cross section such as the one in FIGS. 1A and 1B;

FIG. 4A illustrates a side view of a step of the method of the invention for manufacturing a beam having an A-shaped cross section such as the one in FIGS. 1A and 1B;

FIG. 4B illustrates a side view of another step of the method of the invention for manufacturing a beam having an A-shaped cross section such as the one in FIGS. 1A and 1B;

FIG. 4C illustrates a side view of another step of the method of the invention for manufacturing a beam having an A-shaped cross section such as the one in FIGS. 1A and 1B;

FIG. 4D illustrates a side view of another step of the method of the invention for manufacturing a beam having an A-shaped cross section such as the one in FIGS. 1A and 1B;

FIG. 4E illustrates a side view of another step of the method of the invention for manufacturing a beam having an A-shaped cross section such as the one in FIGS. 1A and 1B;

FIG. 4F illustrates a side view of another step of the method of the invention for manufacturing a beam having an A-shaped cross section such as the one in FIGS. 1A and 1B;

FIG. 4G illustrates a side view of another step of the method of the invention for manufacturing a beam having an A-shaped cross section such as the one in FIGS. 1A and 1B;

FIG. 5 shows a side view of a beam having a circular closed cross section;

FIG. 6 shows a side view of the different elements of the system used to manufacture, according to the method of the invention, a beam having a circular closed cross section such as the one in FIG. 5;

FIG. 7A illustrates a side view of a step of the method of the invention for manufacturing a beam having a circular closed cross section.

FIG. 7B illustrates a side view of another step of the method of the invention for manufacturing a beam having a circular closed cross section;

FIG. 7C illustrates a side view of another step of the method of the invention for manufacturing a beam having a circular closed cross section;

FIG. 7D illustrates a side view of another step of the method of the invention for manufacturing a beam having a circular closed cross section;

FIG. 7E illustrates a side view of another step of the method of the invention for manufacturing a beam having a circular closed cross section;

FIG. 7F illustrates a side view of another step of the method of the invention for manufacturing a beam having a circular closed cross section; and

FIG. 7G illustrates a side view of another step of the method of the invention for manufacturing a beam having a circular closed cross section;

### DETAILED DESCRIPTION OF AT LEAST ONE EMBODIMENT

In the rest of the description and in the appended figures, the terms “upper”, “lower”, “above” and “below” should be considered taking into account an axis (Y) drawn vertically in the plane of the sheet.

The invention relates to a method for manufacturing a beam P1, P2, said beam extending along an axis referred to as a longitudinal axis (X). The beam is created by joining together at least two sections, the sections defining, between one another, a closed cross section. By way of example, the beam may be one with an A-shaped cross section, a cross section in the form of a top-to-tail double omega, etc. Other shapes could, of course, be envisioned.

A beam P1 having an A-shaped cross section may in particular be employed in the structure of an aircraft door, in particular an airplane door. Since the cabin of an airplane is pressurized, its doors need to be designed to ensure reliable closure with a perfectly hermetic seal. The door therefore has a reinforced structure to which the panel that forms part of the external casing of the airplane is fixed. This structure may have two main beams, arranged vertically along two parallel edges of the panel, and beams referred to as longitudinal beams, which each extend between the two main beams, behind the panel. These longitudinal beams may be employed depending on the manufacturing method of the invention.

In a nonlimiting manner, for an application of the airplane door type or similar, the beam may be made of a composite-type material, for example formed of 4 to 5 layers of carbon mat embedded in a thermoplastic resin.

Generally, the method of the invention consists in directly obtaining a beam following two successive stamping openings, ensuring the shaping of the two sections and the assembly thereof.

The method of the invention is based in the use of a system which has:

a first punch, referred to as the lower punch 1, 10;

a second punch, referred to as the upper punch 2, 20;

a single core 3, 30;

possibly a third punch, referred to as the intermediate punch 4, 40.

Two separate plates 5, 50, 6, 60 are placed in the system in order to form the two sections of the beam.

The principle includes in particular in fixing the single core 3, 30 to one of the two, lower or upper, punches during the stamping of the first plate 5, 50 and to the other of the two punches, the upper or lower punch, respectively, during the stamping of the second plate 6, 60.

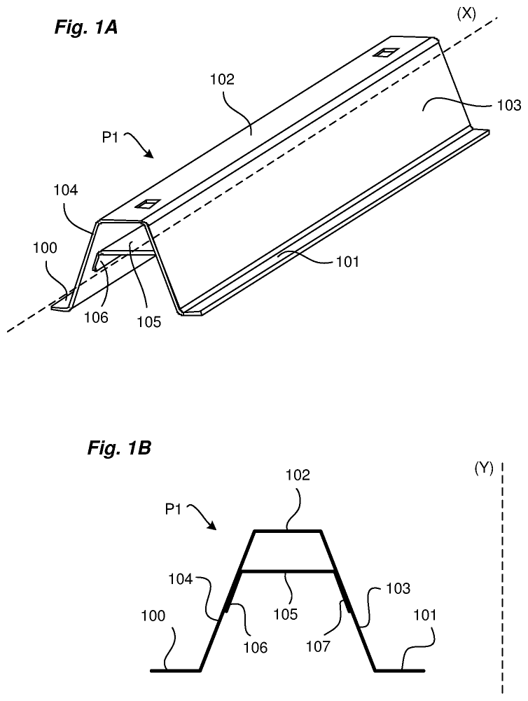

As shown in FIGS. 1A and 1B, in the case of a beam P1 having an A-shaped cross section, this beam is produced by joining together a first section P10 and a second section P11. The first section P10 has, along its entire length:

two support bars 100, 101,

a top wall 102 situated on the opposite side from the support bars,

two side plates 103, 104 extending obliquely toward one another so as each to join a separate support bar to the top bar.

The second section P11 has, along its entire length:

a flat wall 105 and two fixing side plates 106, 107 that are each intended to bear on the internal face of a separate side plate of the first section.

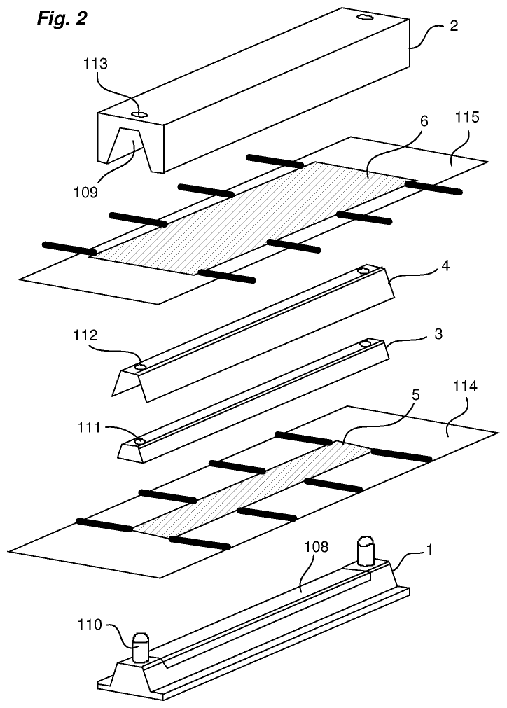

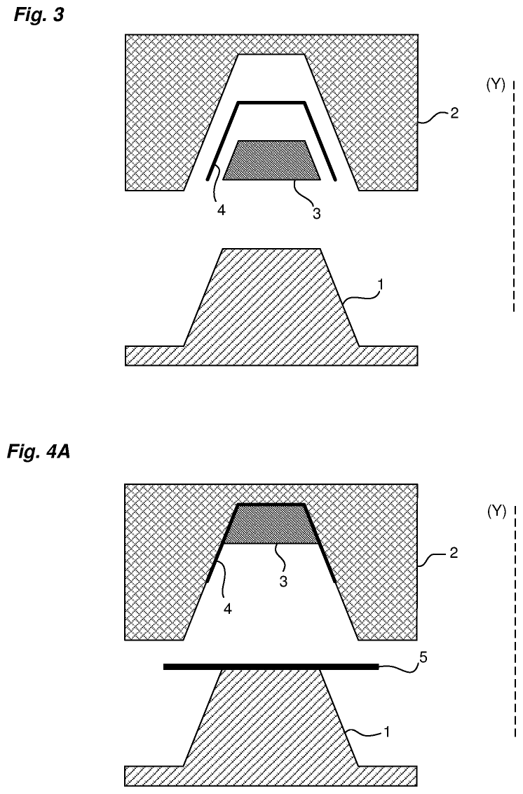

With reference to FIG. 2 and to FIG. 3, for manufacturing such a beam having an A-shaped cross section, the system employed is more particularly the following:

the lower punch 1 has a cross section that defines a raised pattern 108 in the shape of a trapezoid.

the core 3 has a solid cross section in the shape of a trapezoid, intended to complement the raised pattern formed by the lower punch.

the upper punch 2 has a cross section that defines a recessed pattern 109, with a shape complementary to that of the lower punch accompanied by that of the core.

if it is employed, the intermediate punch 4 is in the form of a section having a recessed cross section in the shape of a trapezoid, which is open at its bottom.

Assembly means may be provided to join the core to the lower punch and to the upper punch.

The core 3 may thus have one or more through-openings 111 provided along its plane of symmetry. The lower punch may have one or more corresponding studs 110 extending upwardly above its upper plane. The upper punch and the lower punch have also have openings 112, 113 made on the same axis as those of the core and as the studs of the lower punch, in order to allow the various elements to be assembled by superposition.

In FIG. 2, each plate is positioned on a handling frame 114, 115, allowing it to be handled and to be kept in position during the stamping operation.

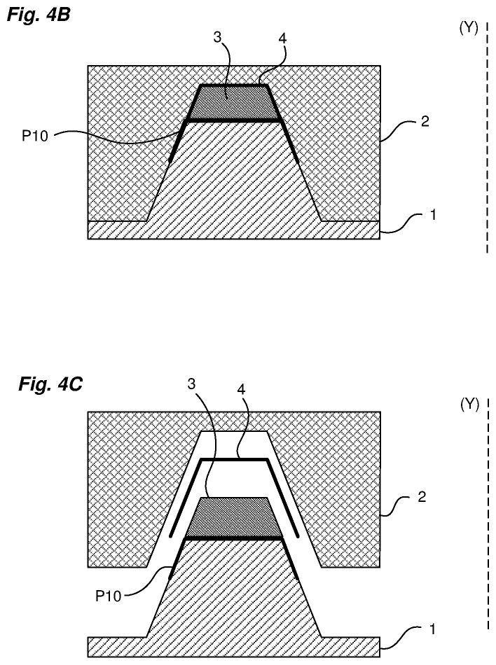

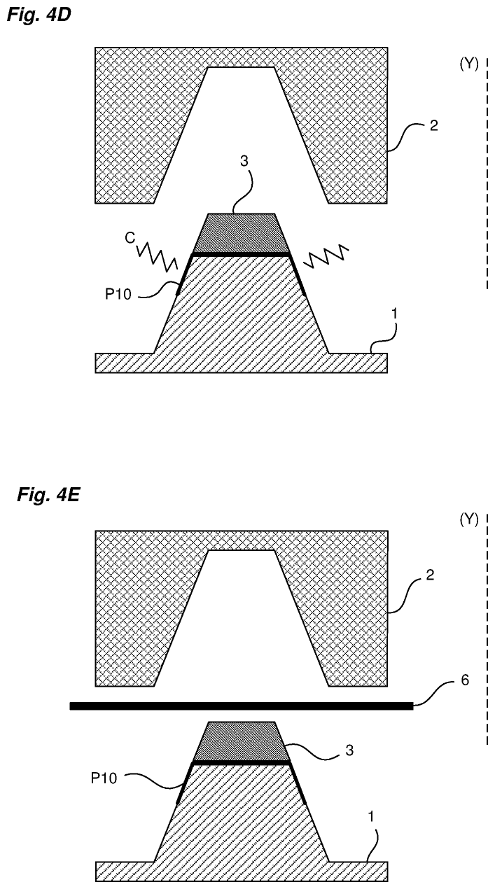

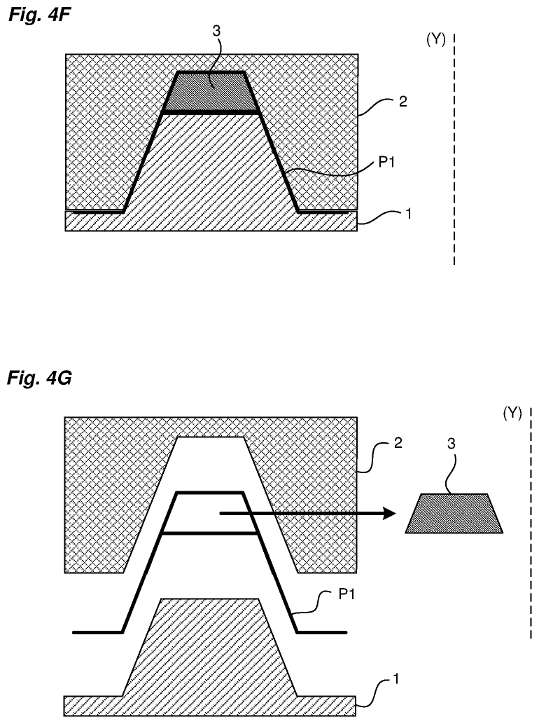

With reference to FIGS. 4A to 4G, for the manufacture of the beam P1 having an A-shaped cross section, the steps are described below. In this embodiment, the intermediate punch 4 is employed, but it may be possible to do without it.

### FIG. 4A:

A first plate 5 to be stamped is disposed on the upper plane of the lower punch 1. The first plate 5 has a rectangular surface.

The lower punch 4 is accommodated in the recessed pattern of the upper punch 2 and the core 3, the intermediate punch 4 being disposed between the upper punch 2 and the core 3.

### FIG. 4B:

The assembly formed of the upper punch 2, of the intermediate punch 4 and of the core 3 is closed over the lower punch 1 in order to stamp the first plate 5 engaged between the lower punch and this assembly. The first plate 5 is stamped, thereby forming a first section P10 having a flat central web and two symmetric oblique flanges, arranged on either side of its upper web.

### FIG. 4C:

The upper punch 2 and the intermediate punch 4 are raised, the core 3 being kept on the upper plane of the central web of the first section P10.

### FIG. 4D:

The intermediate punch 4 is withdrawn.

Optionally, heating C of the two oblique flanges of the first section may be carried out in order to soften the material. This step is optional, since, before stamping, each plate is able to be taken out of a furnace and may thus already be at temperature.

### FIG. 4E:

While maintaining the configuration in FIG. 4D, a second plate 6 is positioned between the upper punch 2 and the assembly formed by the superposition of the lower punch 1, the first section P10 and the core 3.

### FIG. 4F:

The upper punch is closed over the assembly defined above for FIG. 4E, in order to stamp the second plate 6, engaged between the upper punch and this assembly. The second plate 6 has a rectangular surface with a surface area larger than that of the first plate.

### FIG. 4G:

The second plate 6 is stamped, thereby forming a second section P11 having a flat central web and two symmetric oblique flanges, arranged on either side of its upper web and two flat support bars that each extend a separate flange. Its two oblique flanges each come to bear against the external face of an oblique flange of the first section P10, the heating up of said flanges making it possible to ensure they cohere and are joined together, thereby forming the beam P1 having an A-shaped cross section shown in FIGS. 1A and 1B.

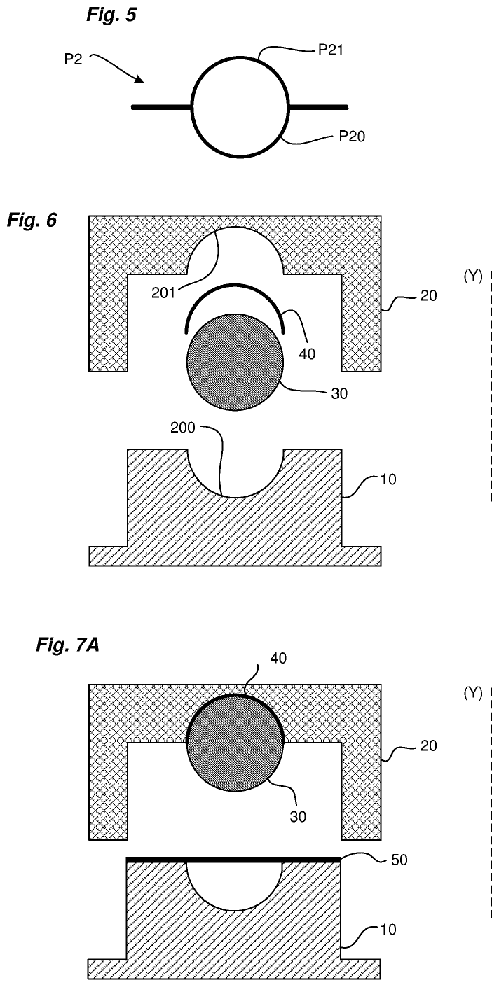

The same principle may apply to the manufacture of a beam P2 produced from two sections P20, P21 in the shape of an omega, joined together top to tail, so as to form a closed cross section of circular shape. This beam is shown in side view in FIG. 5.

With reference to FIG. 6, for manufacturing such a beam P2, the system employed is then the following:

the lower punch 10 has a cross section that defines a recessed pattern 200 in the shape of a semicircle. On either side of its recessed pattern, the lower punch has two bearing planes.

the upper punch 20 has a cross section that defines a recessed pattern 201 in the shape of a semicircle with a diameter identical to that of the lower punch. On either side of its recessed pattern, the upper punch has two bearing planes.

the core 30 has a solid cross section in the form of a disc, so as to be able to be accommodated in the hollow space defined by the two recessed patterns of the upper and lower punches.

if it is employed, the intermediate punch 40 is in the form of a section having a recessed cross section in the shape of a semicircle. It is intended to be positioned between the upper punch and the core.

Fixing means (not shown) may be provided to join the core to the lower punch and to the upper punch.

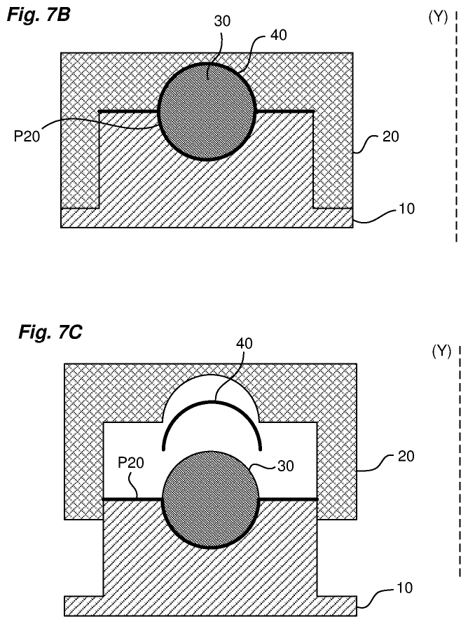

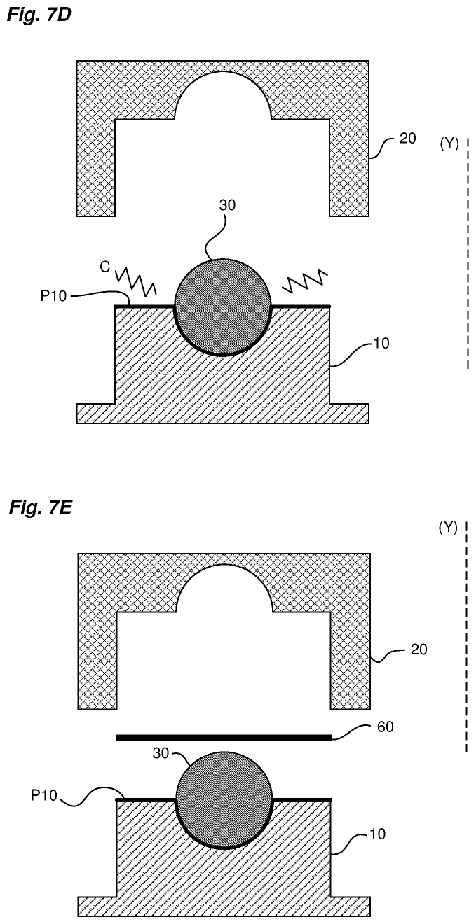

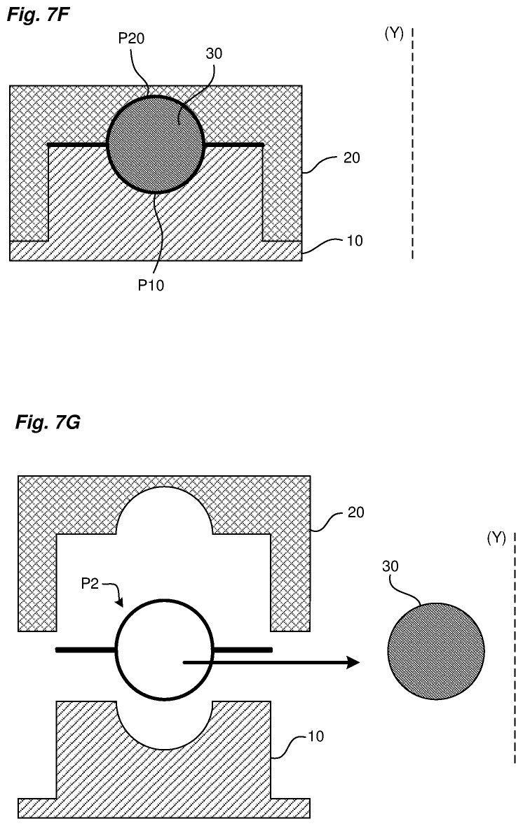

FIGS. 7A to 7G illustrate this principle.

### FIG. 7A:

A first plate 50 is positioned on the bearing planes of the lower punch 10. The first plate 50 has a rectangular surface.

The intermediate punch 40 is accommodated in the recessed pattern of the upper punch and the core 30, the intermediate punch 40 being disposed between the upper punch 20 and the core 30.

### FIG. 7B:

The assembly formed of the upper punch 20, of the intermediate punch 40 and of the core 30 is closed over the lower punch 10 in order to stamp the first plate 50 engaged between the lower punch 10 and this assembly. The first plate 50 is stamped, thereby forming a first section P20 having a central web with a semi-circular cross section and two symmetric, flat lateral flanges, on either side of its central web.

### FIG. 7C:

The upper punch 20 and the intermediate punch 40 are raised, the core 30 being kept on the upper plane of the central web of the first section P20.

### FIG. 7D:

The intermediate punch is withdrawn.

Optionally, heating C of the two lateral flanges of the first section may be carried out in order to soften the material. This step is optional, since, before stamping, each plate is able to be taken out of a furnace and may thus already be at temperature.

### FIG. 7E:

While maintaining the configuration in FIG. 7D, a second plate 60 is positioned between the upper punch 20 and the assembly formed by the superposition of the lower punch 10, the first section P20 and the core 30. The second plate 60 has a rectangular surface with dimensions identical to those of the first plate.

### FIG. 7F:

The upper punch 20 is closed over the assembly defined above for FIG. 7E, in order to stamp the second plate 60, engaged between the upper punch 20 and this assembly.

### FIG. 7G:

The first plate 60 is stamped, thereby forming a second section P21 having a semi-circular central web and two symmetric lateral flanges, arranged on either side of its upper web. Its two lateral flanges each come to bear against the upper face of a lateral flange of the first section, the heating up of said flanges making it possible to ensure they cohere and are joined together, thereby forming the beam having a circular closed cross section.

It should be noted that indexing pins can be provided on the bearing plane of the lower punch 1, 10, in order to make it easier to position the first plate 5, 50.

In a variant, the system may incorporate a hinge mechanism between the upper punch 2, 20 and the lower punch 1, 10, in order to perfectly adjust the upper punch with respect to the lower punch, that is to say without a risk of slipping, during the stamping operations.

By carrying out the stamping of the second plate 6, 60 directly on the first section already formed, the method is simpler, quicker and makes it possible to:

do away with certain operations, in particular fixing, when the fixing is allowed by thermal cohesion between the two sections;

only have a single reference to manage;

reduce the quantity of material necessary for the stamping operations (in particular a single shared core for the two operations);

obtain a lighter beam, by virtue of the elimination of the fixing means of the screw/nut, rivet etc. type.

1. A method for manufacturing a beam (P1, P2) having a closed cross section, said beam being produced by joining together a first section (P10, P20) and a second section (P11, P21), the method having steps of:
producing the first section by a first operation of stamping a first plate (5, 50) between a first punch (1, 10) having a first impression and a second punch (2, 20) having a second impression and incorporating a core (3, 30) that modifies the second impression,
keeping the first section (P10, P20) on the first punch and positioning said core (3, 30) above said first section (P10, P20),
producing the second section (P11, P21) by a second operation of stamping a second plate (6, 60) against said core (3, 30) between said second punch (2, 20) and said assembly formed by the superposition of the first punch (1, 10), the first section (P10, P20) and said core.

2. The method as claimed in claim 1, further comprising wherein a prior step of heating the first plate (5, 50) and the second plate (6, 60).

3. The method as claimed in claim 1, further comprising a step of locally heating at least one region of the first section (P10, P20) obtained after the first stamping operation.

4. The method as claimed in claim 1, wherein an intermediate punch (4, 40) is incorporated between the second punch (2, 20) and the core (3, 30) during the first stamping operation.

5. The method as claimed in claim 4, further comprising a step of withdrawing the intermediate punch (4, 40) after the first stamping operation and before the second stamping operation.

6. A system employed to carry out the manufacturing method as defined in one of claim 1 comprising:
a first punch (1, 10) having a first impression and a second punch (2, 20) having a second impression,
a core (3, 30) intended to be fitted to the first punch in order to modify said first impression or to said second punch in order to modify said second impression;
an intermediate punch (4, 40) intended to be positioned between the second punch (2, 20) and the core (3, 30).

7. The system as claimed in claim 6, wherein the first punch (1, 10) and the second punch (2, 20) have an assembly device to cooperate with corresponding device present on the core.

8. The system as claimed in claim 6, wherein the first punch (1, 10) and/or the second punch (2, 20) have indexing pins arranged so as to ensure the positioning of each plate to be stamped.

9. The system as claimed in claim 6, further including a hinge mechanism arranged between the first punch and the second punch.
